(19) United States
(12) Patent Application Publication
(10) Pub. No.: US 2004/0191633 A1
(43) Pub. Date: Sep. 30, 2004

(54) Electrodes for lithium batteries

(75) Inventors: Christopher S. Johnson, Naperville, IL (US); Michael M. Thackeray, Naperville, IL (US); Jeom-Soo Kim, Naperville, IL (US); Marc A. Anderson, Madison, WI (US); Walter A. Zeltner, Oregon, WI (US)

Correspondence Address: EMRICH AND DITHMAR LLC., Suite 2080, 125 South Wacker Drive, Chicago, IL, 60606, US

(73) Assignee: The University of Chicago, Chicago, IL

(21) Appl. No.: 10/746,211

(22) Filed: Dec. 23, 2003

Related U.S. Application Data
(60) Provisional application No. 60/450,468, filed on Feb. 26, 2003.

(51) Int. Cl. H01M 2/16; B05D 5/12; H01M 4/58; H01M 4/48

(52) U.S. Cl. 429/246; 429/137; 429/231.1; 429/231.95; 427/126.3

(57) ABSTRACT

A positive electrode for an electrochemical cell including a lithium transition-metal-oxide or lithium-transition metal-oxyfluoride having deposited thereon at least one oxide, oxyhydroxide or hydroxide of zirconium, aluminum, titanium, yttrium, silicon or mixtures thereof, the particles being less than 25 nm in longest dimension, but preferably less than 4 nm. A complete cell as well as a battery incorporating the positive electrode is disclosed as is a method of making the positive electrode, cell and battery.

### RELATED APPLICATIONS

This application, pursuant to 37 C.F.R. § 1.78(c), claims priority based on provisional application serial No. 60/450,468 filed Feb. 26, 2003.

The United States Government has rights in this invention pursuant to Contract No. W-31-109-ENG-38 between the U.S. Department of Energy (DOE) and The University of Chicago representing Argonne National Laboratory.

### FIELD OF THE INVENTION

This invention relates, in general, to metal-oxide or metal-oxyfluoride positive electrodes for electrochemical cells and batteries, preferably for rechargeable lithium-ion cells and batteries. More specifically, it relates to lithium-metal-oxides or lithium-metal-oxyfluorides onto which is deposited, preferably but not necessarily as a colloid, at least one or more than one of an oxide, oxyhydroxide or hydroxide of zirconium, aluminum, titanium, yttrium or silicon, optionally in the presence of ions selected from the Group 1a, 2a or 2b elements, to suppress attack of the particles by acidic species from the electrolyte and to stabilize the electrode particles thereby protecting the electrode from capacity loss effects, such as dissolution and oxygen loss during electrochemical cycling of the cells. The invention extends to methods for coating orotherwise treating the lithium-metal-oxides or lithium-metal-oxyfluorides and to electrochemical cells and batteries containing such electrodes.

### BACKGROUND OF THE INVENTION

State-of-the-art lithium-ion cells have a lithiated carbon negative electrode, or anode, (LiₓC₆) and a lithium-cobalt-oxide positive electrode, or cathode, Li₁₋ₓCoO₂. During charge and discharge of the cells, lithium ions are transported between the two host structures of the anode and cathode with the simultaneous oxidation or reduction of the host electrodes, respectively. When graphite is used as the anode, the voltage of the cell is approximately 4 V. The cathode material Li₁₋ₓCoO₂, which has a layered LiMO₂-type structure, is expensive and becomes unstable at low lithium content, i.e., when cells reach an overcharged state at x≧0.5. In layered LiMO₂-type structures, the lithium and M cations, located in octahedral sites, are arranged in alternate layers with each cation layer being sandwiched between sheets of close-packed oxygen anions. Alternative, less expensive electrode materials that are isostructural with LiCoO₂, such as LiCo_{0.2}Ni_{0.8}O₂, LiCo_{0.33}Ni_{0.33}Mn_{0.33}O₂, LiNi_{0.5}Mn_{0.5}O₂ and LiNi_{0.4}Mn_{0.4}Li_{0.2}O₂ are being developed in the hope of replacing at least part of the cobalt component of the electrode. However, all these layered structures, when extensively delithiated are unstable because of the high oxygen activity at the surface of the particles; therefore, the electrode particles tend to react with the organic solvents of the electrolyte or lose oxygen.

Electrodes with a spinel-type structure, such as those in the lithium-manganese-oxide system Li₁₊ₓMn₂₋ₓO₄, are particularly attractive alternatives to LiCoO₂ because, not only are they relatively inexpensive, but they are thermally more stable than Li₁₋ₓCoO₂ or Li₁₋ₓNi_{0.8}Co_{0.2}O₂ at low lithium loadings, and because they do not contribute to the impedance rise of electrochemically cycled lithium-ion cells to the same extent as cells with Li₁₋ₓCoO₂ or Li₁₋ₓNi_{0.8}Co_{0.2}O₂ electrodes. Spinel-type structures are generally characteri by the general formula A[B₂]X₄, in which the A cations reside on the tetrahedral 8a sites, the B cations on the octahedral 16d sites, and the X anions on the 32e sites of a cubic unit cell with prototypic symmetry Fd3m. For lithium battery electrodes, lithium-transition-metal spinel oxides are of the most interest, in which the A cations are predominantly lithium ions and the B cations predominantly the transition metal ions, and the X anions are oxygen ions. However, variations in spinel composition are well known, in which B-type cations can occupy A-sites and vice-versa.

The Li₁₋ₓ[Mn₂]O₄ spinel system has been investigated extensively in the past as an electrode for lithium-ion batteries. A major reason why the spinel system has not yet been fully commercialized is because the electrode is unstable in the cell environment, particularly if the operating temperature of the cells is raised above room temperature, for example, between 40 and 60° C. It is now generally acknowledged that the solubility of Liₓ[Mn₂]O₄ electrodes in acid medium occurs by the disproportionation reaction:

Mn³⁺_{(solid)}→Mn⁴⁺_{(solid)}+Mn²⁺₍ₛₒₗᵤₜᵢₒₙ₎ (1)

during which the Mn²⁺ ions go into solution, and the Mn⁴⁺ ions remain in the solid spinel phase. Such a reaction can occur in lithium-ion cells because the hydrolysis of fluorinated lithium salts such as LiPF₆ with small amounts of residual water in the organic-based electrolyte solvents can generate hydrofluoric acid, HF.

Full electrochemical delithiation of Li[Mn₂]O₄ leaves lambda-MnO₂ with the [Mn₂]O₄ spinel framework. Like many manganese dioxides, lambda-MnO₂ is a powerful oxidizing agent and can be readily reduced. Therefore, any oxygen that may be evolved at the particle surface of the spinel electrode at the top of charge will result in Mn³⁺ ions at the electrode surface; the instability of Mn³⁺ ions at the high potential of the charged cell will also drive the disproportionation reaction (1) shown above, thus damaging the spinel surface and resulting in some irreversible capacity loss of the cell.

The presence of tetragonal Li₂[Mn₂]O₄ has also been observed in very small amounts at the surface of Li[Mn₂]O₄ spinel electrodes at the end of discharge after high rate cycling (C/3 rate) between 4.2 and 3.3 V vs. Li. The compound Li₂[Mn₂]O₄, in which all the manganese ions are trivalent, will be unstable like Li[Mn₂]O₄ at high potentials in a 1M LiPF₆/EC/DMC electrolyte that contains HF, particularly when the lithium cells are operated between 40 and 60° C. In this case, a disproportionation reaction occurs in which MnO dissolves from the particle surface to leave an insoluble and stable Li₂MnO₃ rock-salt phase. This reaction may account for some of the capacity loss of 4-V Li/Liₓ[Mn₂]O₄ cells on long-term cycling.

Substantial efforts have already been made in the past to overcome the stability and solubility problems associated with layered LiCoO₂ and LiNiO₂ electrodes. For example, considerable success has been achieved in the past by stabilizing these electrodes by pretreating the electrode powders with oxide additives such as Al₂O₃ orZrO₂ obtained from metal alkoxide precursors such as solutions containing aluminum ethylhexanoate diisopropoxide (Al(OOC₈H₁₅)(OC₃H₇)₂ or zirconium ethylhexanoisopropoxide (Zr[(OOC₈H₁₅)₂(OCH₃H₇)₂]) and thereafter heating the electrode powders at elevated temperature as described, for example, by J. Cho, Y. J. Kim and B. Park in Chemistry of Materials, Volume 12, page 3788 (2000) and J. Cho, T-J. Kim, Y. J. Kim and B. Park in Electrochemical and Solid State Letters, Volume 4 No. 10, page A159 (2001), respectively, or an aluminum nitrate (Al(NO₃)₃) precursor solution as described by A. M. Kannan and A. Manthiram in Electrochemical and Solid State. Letters, Volume 5 No. 7, page A167 (2002), or a zirconium oxide, polymeric precursor or zirconium oxynitrate (ZrO(NO₃)₂.xH₂O) as described by Z. Chen and J. R. Dahn in Electrochemical and Solid State Letters, Volume 5, No. 10, page A213 (2002), prior to the fabrication of the final electrode thereby making the surface of the LiCoO₂ particles more resistant to electrolyte attack, cobalt dissolution or oxygen loss effects. In the case of a Li[Mn₂]O₄ spinel electrode, partial substitution of the manganese ions with a mono-, di- or trivalent ion (or a combination thereof) changes the composition of the electrode and increases the average oxidation state of the manganese ions above 3.5, thus reducing the amount of Mn³⁺ ions in the fully discharged electrode and consequently reducing the dissolution and lowering the rate of capacity fade of the electrode. Typical examples of substituted electrodes are Li_{1.03}Mn_{1.97}O₄, Li_{1.05}Mn_{1.90}Ni_{0.05}O₄, and LiMn_{1.95}Al_{0.05}O₄. Other approaches to suppress mangan dissolution from the spinel electrode have been taken, for example, protecting the spinel particles with a surface coating, such as a low-melting lithium borate glass as described by G. G. Amatucci, A. Blyr, C. Sigala, P. Alfonse and J. M. Tarascon in Solid State lonics, Volume 104, page 13 (1997) or a coating of LiCoO₂ applied at high temperature (e.g., 700-800° C.) as described by S-C. Park, Y-M. Kim, Y-M. Kang, K-T. Kim, P. S. Lee and J-Y. Lee in Journal of Power Sources, Volume 103, page 86 (2001) or at moderate temperature (e.g., 400° C.), the coatings being more resistant to dissolution in the electrolytes than Li[Mn₂]O₄. Alternatively, a coating of Co₃O₄ has been applied to the electrode particles as described by J. Cho, T-J. Kim, Y. J. Kim and B. Park, in Chemistry Communications, page 1074, (2001). Improvements in the performance of lithium-metal-oxide electrodes have also been obtained by substituting some of oxygen ions with fluorine ions, for example, as disclosed by G. G. Amatucci, A. Blyr, C. Schmutz and J. M. Tarascon in Progress in Batteries and Battery Materials, Volume 16, page 1 (1999). In U.S. patent application US 2001/0046628 A1, R. Oesten, B. Li, N. Nakamura and K. Nitta have disclosed lithium mixed oxide particles coated with one or more layers of alkali metals and metal oxides for improving the properties of electrochemical lithium cells.

The loss of oxygen from charged lithium-transition-metal oxide electrodes, such as LiCoO₂, LiN_{1-y}Co_{y}O₂and LiCo_{1-y-z}Ni_{y}Mn_{z}O₂ (0≦y≦1; 0≦z≦1) electrodes and spinel electrodes such as LiMn₂O₄ can contribute to exothermic reactions with the electrolyte and with the lithiated carbon negative electrode, and subsequently to thermal runaway if the temperature of the cell reaches a critical value. It is believed that coating the electrode particles as described above may also protect the electrode from oxygen loss. Although some success has been achieved in the past to improve the performance of lithium-ion cells by coating lithium-metal-oxide electrode particles, the problems of electrode instability have not yet been fully resolved and further improvements are necessary to improve the overall performance and safety of these cells.

### SUMMARY OF THE INVENTION

This invention relates to improved lithium-metal-oxide or lithium-metal-oxyfluoride positive electrodes for lithium cells and batteries, preferably rechargeable lithium-ion cells and batteries that contain spinel- or layered-type positive electrodes. More preferably, it relates to lithium-metal-oxides or lithium-metal-oxyfluorides onto which is deposited at least one oxide, oxyhydroxide or hydroxide of zirconium, aluminum, titanium, yttrium or silicon, optionally as a colloid and optionally in the presence of metal ions selected from one or more of the Group 1a, 2a or 2b elements, to increase the basicity of the electrode and to improve the stability of the cells and batteries during storage and electrochemical cycling, particularly at temperatures above room temperature. The colloidal additives are applied to the lithium-metal-oxide or lithium-metal-oxyfluoride electrodes preferably such that the zeta potential at the surface of the electrode particles corresponds to a negative value to suppress the attack of the electrode particles by acidic species in the electrolyte and to stabilize the electrode particles in a discharged, charged or partially-charged state, thereby protecting the electrode from capacity loss effects, such as oxygen loss and dissolution effects during electrochemical cycling of the cells. The invention extends to methods for coating or otherwise treating the lithium-metal-oxides or lithium-metal-oxyfluorides and to electrochemical cells and batteries containing such electrodes.

### BRIEF DESCRIPTION OF THE DRAWINGS

The invention consists of certain novel features and a combination of parts hereinafter fully described, illustrated in the accompanying drawings, and particularly pointed out in the appended claims, it being understood that various changes in the details may be made without departing from the spirit, or sacrificing any of the advantages of the present invention.

FIGS. (a)-(e) depict the powder X-ray diffraction patterns of a) an uncoated LiMn₂O₄ spinel electrode; b) a LiMn₂O₄ spinel electrode coated with colloidal ZrO₂; c) a ZrO₂-coated LiMn₂O₄ spinel electrode in which LiNO₃ had been added to the suspension such that the Li:Zr ratio was 0.1:1.0; d) a LiMn₂O₄ spinel electrode coated with colloidal Al₂O₃; and e) a LiMn₂O₄ spinel electrode coated with colloidal SiO₂;

FIGS. 2(a)-(b) depict the powder X-ray diffraction patterns of a) an uncoated LiNi_{0.05}Mn_{0.5}O₂ electrode with a layered-type structure; and b) a LiNi_{0.5}Mn_{0.5}O₂ electrode coated with colloidal ZrO₂;

FIGS. 3(a)-(d) depict transmission electron microscope images of a) colloidal ZrO₂ deposited onto LiMn₂O₄ spinel particles as a discrete coating; b) an enlargement of a) showing primary ZrO₂ particles less than 4 nm in dimension; c) colloidal Al₂O₃ particles less than 4 nm in dimension deposited onto LiMn₂O₄ spinel particles; and d) colloidal SiO₂ particles less than 4 nm in dimension deposited onto LiMn₂O₄ spinel particles;

FIGS. 4(a)-(b) depict electron diffraction patterns of a) microcrystalline LiMn₂O₄ spinel particles in the electrode and b) amorphous ZrO₂ at the surface of the LiMn₂O₄ particles such as in FIG. 3b;

FIGS. 5(a)-(c) depict the electrochemical voltage profile for cycles 15-22 of a) a standard Li/LiMn₂O₄ cell operated at room temperature (RT); b) at 50° C., and c) a Li/LiMn₂O₄ cell with a LiMn₂O₄ electrode coated with colloidal ZrO₂, operated at 50° C.;

FIG. 6 depicts plots of electrode capacity vs. cycle number of cells operated at 50° C. for: a) a standard Li/LiMn₂O₄ cell with an uncoated spinel electrode; b) a Li/LiMn₂O₄ cell with a spinel electrode coated with colloidal ZrO₂; c) a Li/LiMn₂O₄ cell with a spinel electrode coated with colloidal ZrO₂ in the presence of LiNO₃ and d) a Li/LiMn₂O₄ cell with a spinel electrode coated with colloidal SiO₂;

FIGS. 7(a)-(b) depict cyclic voltammograms recorded at 50° C. of a) an uncoated LiMn₂O₄ spinel electrode and a spinel electrode coated with colloidal ZrO₂;

FIG. 8 depicts plots of electrode capacity vs. cycle number of cells operated at 50° C. for: a) a Li/LiMn₂O₄ cell with a spinel electrode coated with colloidal ZrO₂ of dimensions of less than 4 nm; and b) a Li/LiMn₂O₄ cell with a spinel electrode coated with colloidal ZrO₂ of average dimensions of approximately 20 nm;

FIG. 9 depicts plots of electrode capacity vs. cycle number of cells operated at 50° C. for: a) a Li/Li_{1.03}Mn_{1.97}O₄ cell with an uncoated spinel electrode; and b) a Li/Li_{1.03}Mn_{1.97}O₄ cell with a spinel electrode coated with colloidal TiO₂;

FIG. 10 depicts plots of electrode capacity vs. cycle number of cells operated at 50° C. for: a) a Li/Li_{1.05}Mn_{1.90}Ni_{0.05}O₄ cell with an uncoated spinel electrode; and b) a Li/Li_{1.05}Mn_{1.90}Ni_{0.05}O₄ cell with a spinel electrode coated with colloidal ZrO₂;

FIGS. 11(a)-(b) depict the electrochemical voltage profiles between 4.6 and 2.0 V for cycles 1-20 at 50° C. of a) a standard Li/LiNi_{0.5}Mn_{0.5}O₄ cell with a layered LiNi_{0.5}Mn_{0.5}0₄ electrode; and b) a Li/LiNi_{0.5}Mn_{0.5}O₄ cell with a layered LiNio_{0.5}Mn_{0.5}O₄ electrode coated with colloidal ZrO₂;

FIG. 12 depicts plots of electrode capacity vs. cycle number of cells operated at 50° C.: a) a standard Li/LiNi_{0.5}Mn_{0.5}O₄ cell with a layered LiNi_{0.5}Mn_{0.5}O₄ electrode; b) a Li/LiNi_{0.5}Mn_{0.5}O₄ cell with a layered LiNi_{0.5}Mn_{0.5}O₄ electrode coated with colloidal ZrO₂;

FIG. 13 depicts a schematic illustration of an electrochemical cell; and

FIG. 14 depicts a schematic illustration of an example of a battery employing the cells of the invention.

### DETAILED DESCRIPTION OF PREFERRED EMBODIMENTS

This invention relates to improved lithium-metal-oxide or lithium-metal-oxyfluoride positive electrodes for lithium cells and batteries, preferably rechargeable lithium-ion cells and batteries as well as methods of making same. More specifically, it relates to electrodes comprised of lithium-metal-oxides or lithium-metal-oxyfluorides, preferably with spinel-type or layered-type structures, containing or mixed with at least one colloidal oxide, oxyhydroxide or hydroxide of zirconium, aluminum, titanium, yttrium or silicon, the colloidal particles being less than 25 nm in longest dimension and optionally containing, or mixed with, ions of at least one of the Group 1a, 2a, or 2b metal elements, to increase the basicity of the electrode and to improve the stability of the cells and batteries during storage and electrochemical cycling, particularly at temperatures above room temperature, typically between 40 and 60° C., that can be reached in devices such as laptop computers or cell phones if allowed to stand in sunlight.

Many of the electrolyte salts that are of interest to the lithium battery industry are fluorinated salts such as LiPF₆, LiAsF₆ and LiBF₄. They are dissolved in organic carbonate solvents such as ethylene carbonate (EC), diethylcarbonate (DEC), dimethylcarbonate (DMC) and propylene carbonate (PC). LiPF₆ is the most commonly used lithium salt in rechargeable lithium-ion batteries that power portable electronic devices such as cellular telephones, laptop computers and camcorders, whereas LiAsF₆ is commonly used in primary Li/Ag₂V₄O₁₁, batteries for medical devices, such as cardiac defibrillators. It is well known thatfluorinated salts, particularly LiPF₆, can undergo hydrolysiswhen trace amounts of water are present in the electrolyte to form hydrofluoric acid, HF. Such acidic species can attack and degrade the surface of lithium-metal-oxide or lithium-metal-oxyfluoride electrodes of lithium cells, the best known example being the dissolution of the spinel electrode LiMn₂O₄, as previously described, thereby leading to severe capacity loss effects, particularly when the operating temperature of the lithium cells reaches 40 to 60° C. Moreover, when lithium-metal-oxide or lithium-metal-oxyfluoride electrodes are fully charged, oxygen loss can occur, which also results in capacity loss of the electrode and the cell. In attempts to improve the electrochemical stability of layered LiCoO₂ and LiNiO₂ electrodes, several studies of the electrochemical behavior of various coated LiCoO₂ and LiNiO₂ electrodes in lithium cells have been previously undertaken, for example, by Cho et al in J. Cho, T-J. Kim, Y. J. Kim and B. Park, Angewandte Chemie—International Edition, Volume 40, No. 18, page 3367 (2001), in which ZrO₂, A1₂O₃, TiO₂, and B₂O₃ were used to coat LiCoO₂ electrodes. Of these coatings, ZrO₂ and Al₂O₃ were reported to be the most effective in stabilizing the electrochemical performance of the lithium cells at elevated temperature, the reasons for which are not yet fully understood.

In this invention, particles, preferably colloidal particles, selected preferably according to their amphoteric properties, are used as additives to significantly improve the electrochemical cycling stability of spinel- and layered-type electrodes in lithium-ion cells. It is believed that colloidal particles provide significant advantages because they have nano-dimensions, high surface area, porosity and reactivity and can therefore be deposited at or near to the surface of spinel- and layered-type electrode particles to effectively scavenge unwanted species in the electrolyte, notably acidic species such as HF, thereby protecting the electrode particles from corrosion and enhancing their structural and electrochemical properties. In addition, it is believed that a negatively charged colloid particle surface may electrostatically repel the corrosive F⁻ ions in the electrolyte and may prevent these ions from attacking the electrode surface.

In one embodiment of this invention, the lithium-metal-oxide or lithium-metal-oxyfluoride electrodes can be treated with one or more colloidal suspensions of ZrO₂, Al₂O₃ AlOOH, TiO₂, Y₂O₃ or SiO₂. In a second embodiment of the invention, the colloidal suspensions are used either independently or mixed at the molecular level during the production of the colloids to form, for example, yttrium-stabilized zirconium oxide colloidal particles or zirconium titanate colloidal particles, or the like. In a third embodiment of the invention, these colloidal suspensions can be used in conjunction with compounds containing other amphoteric ions selected from one or more of the Group 1a, 2a and 2b metallic elements, preferably from Li+ (Group 1a), Mg²⁺ (Group 2a), Ca²+ (Group 2a), Ba^{2 +} (Group 2a), Zn²⁺ (Group 2b) ions either in solution, solid, or colloidal form. The ions of the Group 1a, 2a and 2b elements are added to the suspensions, preferably in an atomic ratio to zirconium, aluminum, titanium, yttrium or silicon which is less than or equal to 2:1, preferably 1:1, and more preferably 0.1:1. Although the ZrO₂, Al₂O₃, AlOOH, TiO₂, Y₂O₃ and SiO₂ colloidal particles may themselves be amphoteric in nature, the applicants believe that the electrochemical properties of such materials, particularlywhen applied as coatings, or in close proximity to, or in mixtures with the lithium-metal-oxide or lithium-metal-oxyfluoride electrode particles, are significantly enhanced by the addition of one or more Group 1a, 2a or 2b ions. The colloidal suspension preferably contains ZrO₂, Al₂O₃ or AlOOH, most preferably ZrO₂, whereas the amphoteric ions are preferably Li+ ions that can be added to the suspension in water-soluble form, such as LiNO₃.

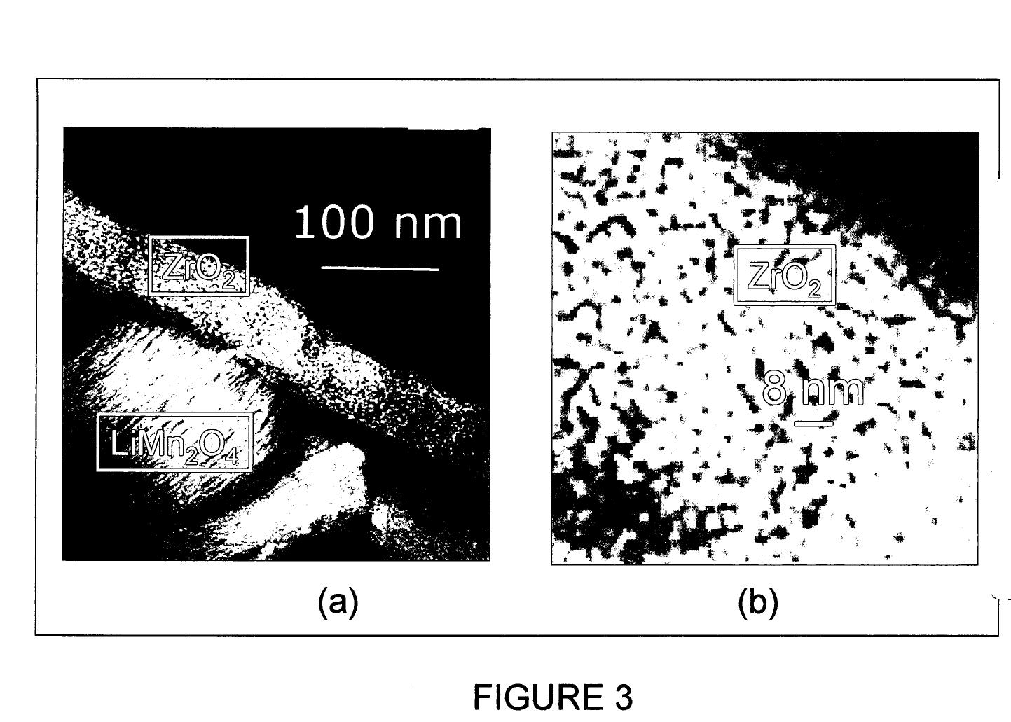

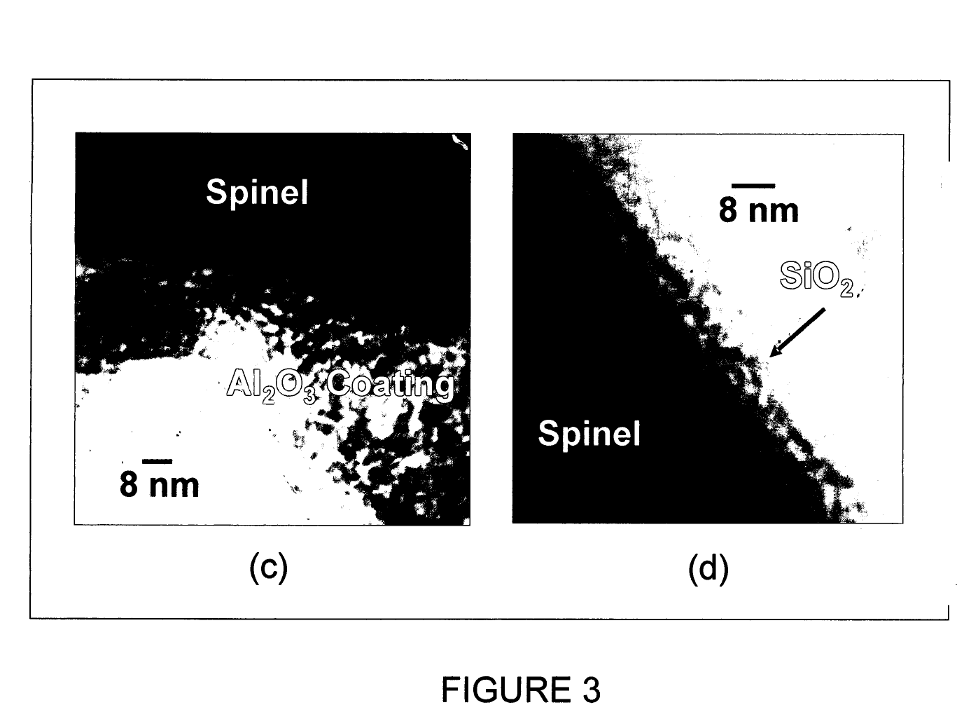

In a further embodiment of the invention, when Group 2a ions (Mg²⁺, Ca²⁺, Ba²⁺) are used in colloidal form, they may be used independently of the ZrO₂, Al₂O₃, AlOOH, TiO₂, Y₂O₃ or SiO₂ colloidal suspensions. Another particular advantage of using metal oxide electrodes with colloidal coatings is that it is possible to control the thickness and architecture of the surface films at moderate temperatures, for example, between 100 and 500° C., preferably between 300 and 400° C., to tailor the porosity of the films and to alter the isoelectric point (pH) of the electrode surface to a desired value. Moreover, effective coatings can be achieved because nanoscopic colloidal particles can be substantially less than 25 nm in dimension, preferably less than 10 nm in dimension, more preferably less than 4 nm in dimension, thereby allowing the lithium-metal-oxide or lithium-metal-oxylfuoride electrode particles to be coated near the molecular level, thus enhancing their scavenging ability in comparison to particles and coatings that are sintered and fired at temperatures higher than 500° C. A particular advantage of using colloidal particles less than 4 nm in diameter is that it is possible to pack such small particles tightly and randomly, as shown in particular by FIG. 3d in which the particles are packed in a near close-packed arrangement, and thereby to control the porosity and surface architecture of the films. The use of particles less than 4 nm in dimension and the control of porosity and surface architecture by using a relatively low temperature of heat treatment, such as 300-400° C. as shown for example in FIG. 3(b) are believed to be significant advantages over that which has been taught by R. Oesten, B. Li, N. Nakamura and K. Nitta in U.S. patent application US 2001/0046628 A1, in which a LiMn₂O₄ spinel electrode was coated with an alumina sol containing particles with diameter 4-40 nm in the presence of LiOH, the coated electrode being fired at 700° C. and being found to be more stable to acid compared to an uncoated LiMn₂O₄ spinel electrode. It is believed that the use of high firing temperatures such as 500-780° C., which are the preferred temperatures taught by U.S. patent application US 2001/0046628 A1, will cause sintering of the small (<4 nm) colloidal particles as taught by this invention, reduce the porosity of the coating and decrease the effectiveness of the coating as an acid scavenger.

In a preferred embodiment of the invention, the zeta potential at the surface of the electrode particles is negative such that it can be used to counteract the attack of the particles by acidic species in the electrolyte and to stabilize the electrode particles in a discharged, charged or partially-charged state, thereby protecting the electrode from capacity loss effects, such as metal cation dissolution effects and oxygen loss during electrochemical cycling of the cells. A particular advantage of using Group 1a, 2a and 2b ions in conjunction with the colloidal particles is that these ions form salts with fluoride ions, for example, LiF, MgF₂, CaF₂, BaF₂ and ZnF₂ that are insoluble or largely insoluble in the organic-electrolyte solvents used in lithium batteries, thereby acting as additional scavengers for fluoride ions in the electrolyte.

In a preferred embodiment of the invention, the colloidal additives are deposited onto to the lithium-metal-oxide or-lithium-metal-oxyfluoride electrode as a surface coating less than 100 nm thick, preferably less than 50 nm thick, more preferably less than 20 nm thick, and most preferably less than 10 nm thick. However, it can be readily understood that the colloidal additive, optionally containing or mixed with ions of at least one of the Group 1a, 2a and 2b elements may of itself be amphoteric in nature and therefore have the same property of neutralizing any acidic species in the electrolyte without adhering to the surface of the lithium-metal-oxide or lithium-metal-oxyfluoride electrode particles but merely by being present therewith. For example, it is believed that ZrO₂ particles with nano-size dimensions act as effective scavengers for HF species in the electrolyte to form complex compounds such as oxonium-zirconium-fluoride-hydrates, as reported in JCPDS Powder Diffraction Files, 79-0023 that can be represented in component notation as ZrO₂.5HF or alternatively, ZrF₄.HF.2H₂O. Furthermore, it is believed that because Al₂O₃ particles have a strong affinity for both HF and H₂O they can form hydrogen-aluminum-fluoride-hydrates, such as those as reported in JCPDS Powder Diffraction Files, 79-0129 and 79-0130, that can be represented in component notation as Al₂O₃.12HF.9H₂O and Al₂O₃.10HF.7H₂O, respectively. In this respect, the strong affinity of Al₂O₃ for H₂O may affect the coating process, because the reaction between Al₂O₃ and H₂O can form AlOOH, such as boehmite. It is also possible that hydroxides such as Al(OH)₃ may form. This invention therefore extends to include colloidal oxyhydroxide and hydroxide particles and suspensions. Colloidal suspensions containing AlOOH or Al(OH)₃ particles are herein simply referred to as Al₂O₃ colloidal suspensions, for convenience. Lithium-metal-oxide particles treated with an Al₂O₃ colloidal suspension have been found to coagulate, which is attributed to the formation of AlOOH at the particle surface that may contribute to the microporosity of the coatings to allow ready access of the lithium ions in the electrolyte to the electrode particles. It has been discovered, however, that coagulation can be controlled by adding a LiNO₃ solution to an Al₂O₃ suspension or a solution containing aluminum ions during the coating process, for example, such that the Li:Al atom ratio is 1:1, which corresponds (after removal of water by heat-treatment) to the formation of a coating with overall composition LiAlO₂.

In general, the principles of this invention can be extended to include metal oxides or metal oxyfluorides, particularly those used by the lithium battery industry as electrodes such as Ag₂V₄O₁₁. When the term “transition metal oxide”, oxyhydroxide or hydroxide” is used in this application, it includes oxides, oxyhydroxide or hydroxides of alloys of transition metals in which the transition metal is present in greater than 50 atom percent, such as Ag₂V₄O₁₁, oxide. The following examples describe the principles of the invention and possible methods of synthesizing the lithium-metal-oxide electrodes of this invention as contemplated by the inventors, but they are not to be construed as limiting examples.

### EXAMPLES

Sample Preparation

Spinel samples having the nominal compositions LiMn₂O₄ and Li_{1.03}Mn_{1.97}O₄ were obtained from Carus Chemical Company. The spinel powders had an average surface area of approximately 3 m²/g and consisted of agglomerated secondary particles with an average size of approximately 12 μm. Standard LiMn₂O₄ samples and substituted spinel samples with the composition Li_{1.05}Mn_{1.90}Ni_{0.05}O₄ were also prepared by first dissolving manganese acetate and the appropriate amounts of lithium acetate and nickel acetate in distilled water, mixing the resulting solution with glycolic acid while stirring continuously. Thereafter, ammonium hydroxide was added slowly to the solution to control the pH at ˜8. The solution was heated at 70 ° C. to evaporate the water to yield a transparent gel that was subsequently decomposed at 400 ° C. for 5 h in air. The resulting powder was pressed into pellets and heated at 800° C. for an additional 5 h to obtain the final spinel product.

Layered LiMo_{0.5}Ni_{0.5}O₂ electrodes were prepared according to the following procedure. First, a Mn_{0.5}Ni_{0.5}(OH)₂ precursor was prepared by precipitation from a basic NaOH solution of Ni(NO₃)₂ and Mn(NO₃)₂ at a pH of approximately 11. The Mn_{0.5}Ni_{0.5}(OH)₂ precursor was reacted with a stoichiometric amount of LiOH, first at 480° C. and then at 900° C. for 10 h in air; thereafter, the samples were rapidly quenched (also in air).

The lithium-metal-oxide spinel and layered samples were treated with colloidal suspensions to generate the electrodes of this invention by the following method. In general, the method consists of making a lithium-metal-oxide or lithium-metal-oxyfluoride positive electrode in which a lithium-metal-oxide or lithium-metal-oxyfluoride electrode particles are stirred in at least one colloidal suspension of zirconium, aluminum, titanium, yttrium or silicon oxide, oxyhydroxide or hydroxide, dried, and fired at a temperature between 100 and 500° C., preferably between 300 and 400° C. The ZrO₂ and TiO₂ colloidal suspensions were prepared according to the method described by Xu and Anderson in the Journal of Materials Research, Volume 6, page 1073 (1991); the SiO₂ colloidal suspensions were prepared according to the method described by Chu, Tejedor-Tejedor and Anderson, in the Proceedings of the Materials Research Society, Volume 346 and the Al₂O₃ colloidal suspensions were prepared according to the method described Anderson, Gieselmann and Xu in the Journal of Membrane Science, Volume 39, page 243 (1988). For example, these methods can be used to synthesize SiO₂ and ZrO₂ colloidal particles with an average dimension less than 4 nm. Samples of colloidal suspensions of ZrO₂ were also sourced directly from Alfa Aesar. The average dimension of the ZrO₂ particles in these samples was typically 20 nm. The colloidal suspensions were, added to the lithium-metal-oxide powders optionally in the presence of a nitrate of a Group 1a, 2a or 2b element, with magnetic stirring, in amounts that would not significantly decrease the capacity of the lithium-metal-oxide electrode, typically 4 to 5 weight percent of, for example, ZrO₂, Al₂O₃, TiO₂, SiO₂. For example, by adding 4 weight percent ZrO₂ to a LiMn₂O₄ sample, the theoretical capacity of the electrode is lowered from 148 mAh/g to 142 mAh/g. Stirring was continued for about 40 minutes with limited heating to ensure thorough mixing of the colloid with the lithium-metal-oxide particles. The mixture was then placed in an oven at 70° C. overnight to drive off the remaining physisorbed water. The resulting powderwas fired in air, typically between 100 and 500° C., preferably 300-400° C., for 4 hours using a ramp of 4° C./min to dry and obtain the final electrode product. For example, a layered LiMno_{0.5}Ni_{0.5}O₂ electrode coated with 4 weight percent ZrO₂, heated to 300° C., showed a capacity loss of 0.7 mAh/g per cycle over 45 cycles, whereas the capacity loss of a similar electrode heated to 500° C. was 1.0 mAh/g per cycle over 45 cycles, i.e., 43% faster, thereby demonstrating the advantage of using the lower heat treatment temperature.

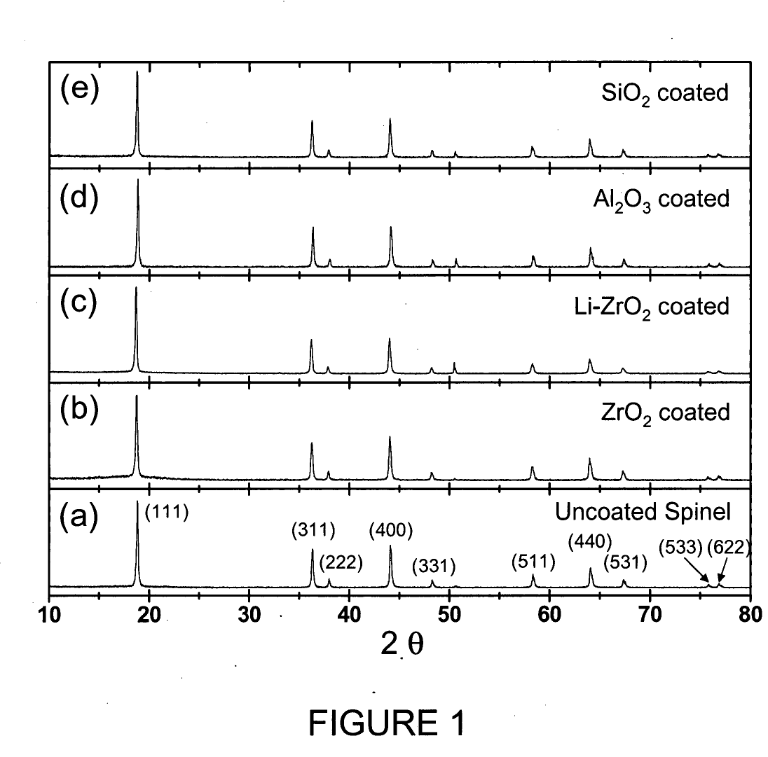

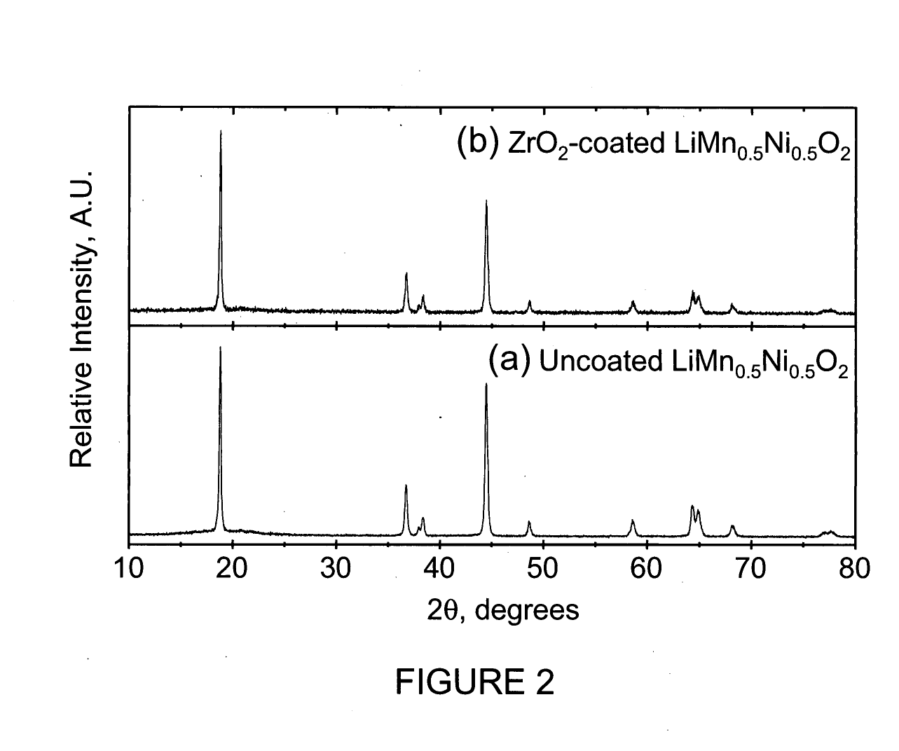

The powder X-ray diffraction patterns of spinel and layered lithium-metal oxides, after treatment with colloidal suspensions and firing at 300-400° C. showed no significant differences to the patterns of the parent untreated (uncoated) compounds, as shown in FIG. 1 for (a) uncoated LiMn₂O₄; (b) ZrO₂-coated (4 wt %) LiMn₂O₄ (400° C.); (c) ZrO₂-coated (4 wt %) LiMn₂O₄ (300° C.), in which LiNO₃ had been added to the suspension such that the Li:Zr ratio was 0.1:1.0, hereafter referred to as the Li—ZrO₂-coated LiMn₂O₄ sample; (d) Al₂O₃-coated (4 wt %) LiMn₂O₄ (400° C.); (e) SiO₂-coated (4 wt %) LiMn₂O₄ (400° C.), and in FIG. 2 for (a) uncoated LiMn_{0.5}Ni_{0.5}O₂ and (b) ZrO₂-coated (4 wt %) LiMn_{0.5}Ni_{0.5}O₂ (300° C.).

Morphological Characterization

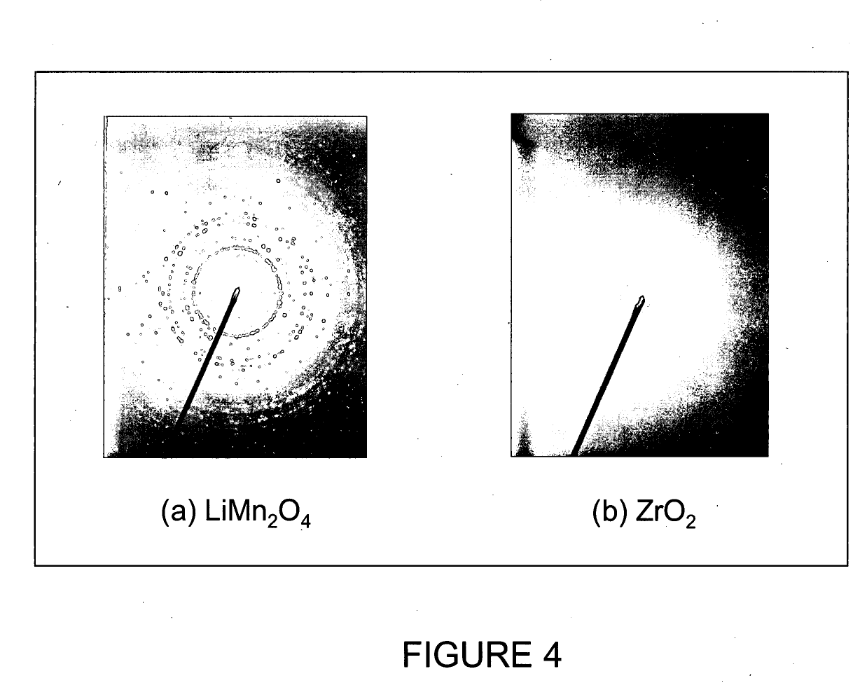

Particle size and morphological properties of the coated lithium-metal-oxide electrodes were characterized by high-resolution transmission electron microscopy on a JEOL-JEM 4000 FEX-1 instrument. Images of ZrO₂-treated LiMn₂O₄ electrode powders are shown in FIGS. 3a and 3b. FIG. 3a shows clearly that the ZrO₂ colloidal additive, prepared by the method of Xu and Anderson, as referenced hereinbefore, is deposited as a discrete layer, approximately 40-50 nm thick on the surface of LiMn₂O₄ grains that were more than 100 nm in dimension, whereas the image in FIG. 3b, reveals that the ZrO₂ coatings are porous and consist of aggregates of extremely small colloidal primary particles less than 4 nm in dimension. Likewise, FIG. 3c and FIG. 3d show primary SiO₂ and Al₂O₃ particles less than 4 nm in dimension. FIG. 4 shows electron diffraction patterns of a) small, microcrystalline LiMn₂O₄ particles, as evident from the multitude of diffraction spots and their irregular positions in the diffraction patterns, and b) the ZrO₂ coating, which appears amorphous consistent with the extremely small (<4 nm) ZrO₂ colloidal particles that comprise the coating.

Electrochemical Evaluation

Electrochemical evaluations of the lithium-metal oxide electrodes were undertaken in lithium cells by the following typical procedures. Electrodes were fabricated from an intimate mixture of 84 wt % of the standard lithium-metal-oxide or coated lithium-metal oxide powders, 8 wt % polyvinylidene difluoride (PVDF) polymer binder (Kynar, Elf-Atochem), 4 wt % acetylene black (Cabot), and 4 wt % graphite (SFG-6, Timcal) slurried in 1-methyl-2-pyrrolidinone (NMP) (Aldrich, 99+%). An electrode laminate was cast from the slurry onto an Al current collector foil using a doctor-blade. The laminate was subsequently dried first at 75° C. for 10 h, and then under vacuum at 70° C. for 12 h. Final laminate thicknesses were typically about 60 μm. Coin-type cells (size CR₂₀₃₂, Hohsen) with a lithium foil counter electrode (FMC Corporation, Lithium Division) and a polypropylene separator (Celgard 2400) were constructed inside a helium-filled glovebox (<5 ppm, H₂O and O₂). The electrolyte used in the lithium cell was typically 1 M LiPF₆ in ethylene carbonate (EC):diethyl carbonate (DEC) (1:1 mixture). The cells were cycled and evaluated at room temperature and at 50° C. using a Maccor Series 2000 tester under galvanostatic mode with a constant current density selected between 0.1 and 0.3 mA/cm².

Cyclic voltammetry data of lithium-metal-oxide electrodes and their coated products were collected with a PAR273 potentiostat using a voltage window of 4.5-3.2 V at a sweep rate of 0.02 mV/s.

The advantages of using lithium-metal-oxide electrodes treated with colloidal coatings in lithium cells in accordance with the principles of this invention are described and demonstrated in the following examples:

### EXAMPLE 1

ZrO₂-Coated LiMn₂O₄ Spinel Electrodes

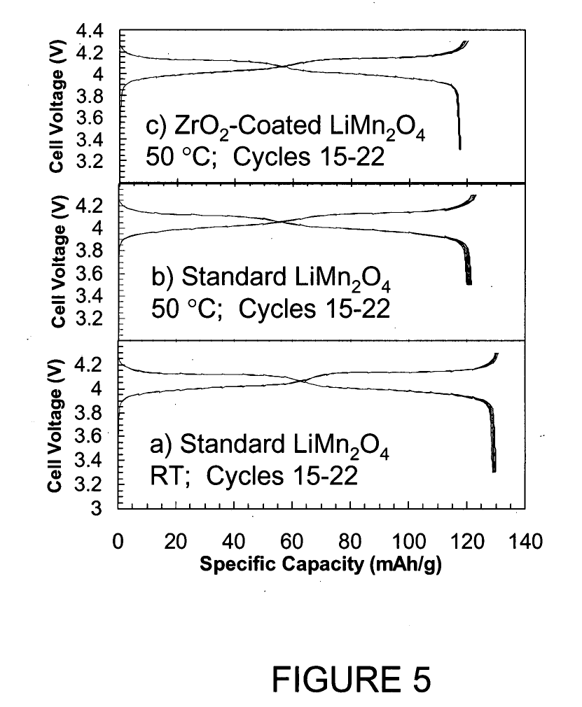

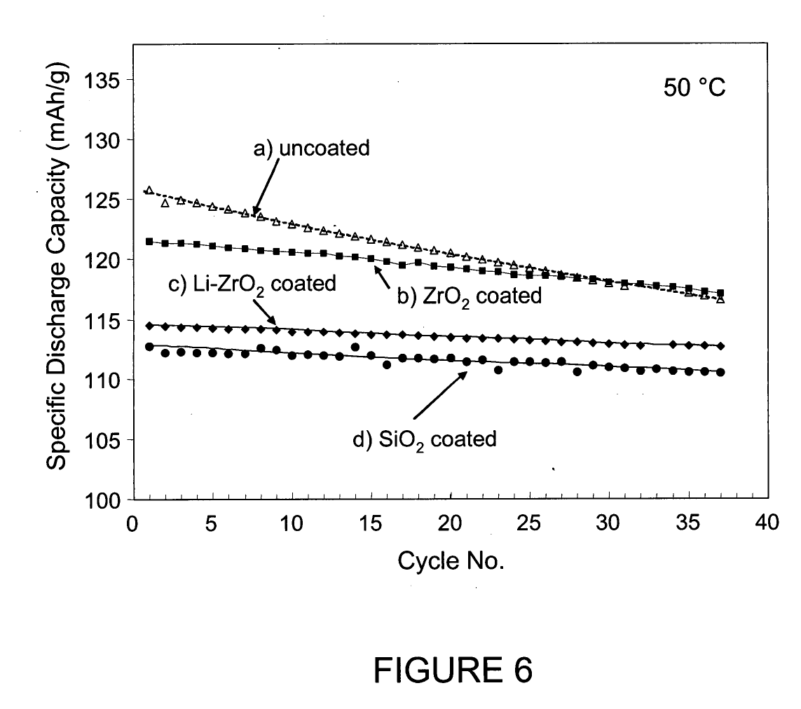

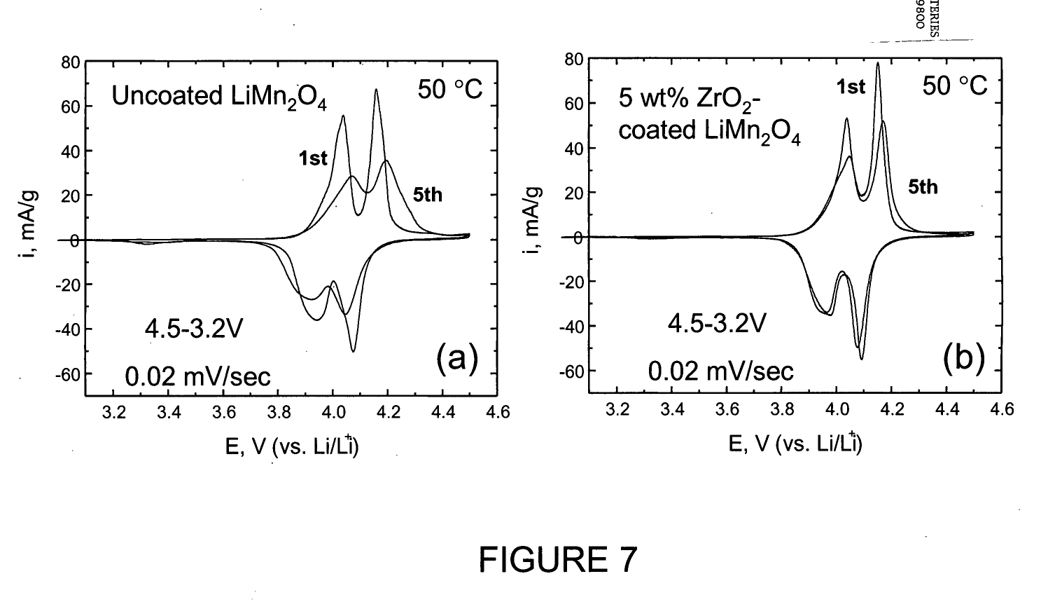

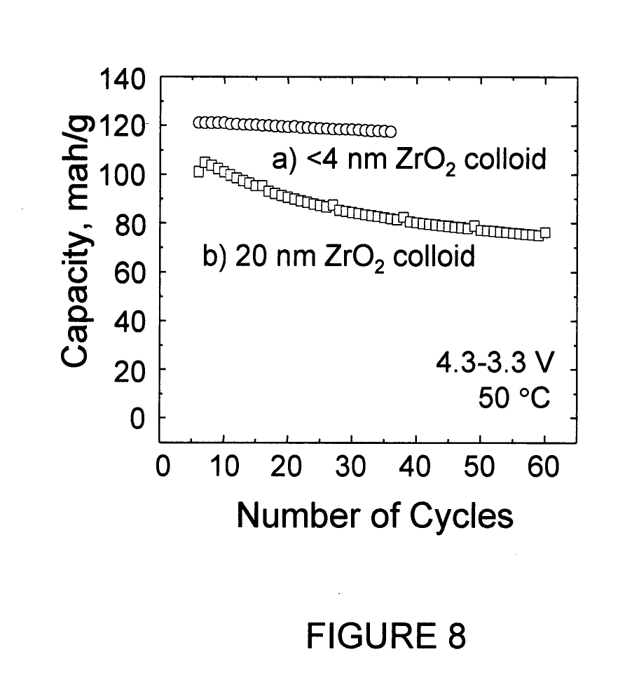

Typical voltage profiles of a lithium cell with a LiMn₂O₄ spinel-type electrode are shown in FIG. 5. The profiles of a standard LiMn₂O₄ electrode, charged and discharged between 4.3 and 3.3 V at room temperature (RT) and at 50° C. are shown in FIGS. 5a and 5b, respectively, for cycles 15 and 22; the voltage profiles of a corresponding cell with a LiMn₂O₄ electrode, treated with 4 wt % ZrO₂, at 50° C. are shown in FIG. 5c. Although the shapes of the voltage profiles of the individual cells are not significantly different, the data show that Li/LiMn₂O₄ cells show significant capacity fade at 50° C. (FIG. 5b) compared to room temperature (FIG. 5a) but that significantly superior cycling stability could be obtained at 50° C. when a ZrO₂-treated LiMn₂O₄ electrode was used (FIG. 5c). The enhanced cycling stability from the ZrO₂-treated LiMn₂O₄ electrode at 50° C. is clearly evident in FIG. 6, in which electrode capacity vs. cycle number plots show that a standard LiMn₂O₄ electrode loses capacity at rate of 0.25 mAh/g per cycle, whereas the rate of capacity fade of the ZrO₂-treated LiMn₂O₄ electrode is significantly lower (0.12 mAh/g per cycle. The cyclic voltammogram of a ZrO₂-coated (5 wt %) LiMn₂O₄ electrode, which clearly shows a smaller shift of the oxidation and reduction peaks during electrochemical cycling in comparison to the cyclicvoltammogram of the uncoated LiMn₂O₄ electrode (FIGS. 7a and 7b), provides convincing evidence that the colloidal ZrO₂ coating stabilizes the LiMn₂O₄ electrode surface to electrochemical cycling, notably at 50° C. The capacity vs. cycle number plots in FIG. 8 for lithium cells with ZrO₂-coated LiMn₂O₄ electrodes, cycled between 4.3 and 3.3 V at 50° C., show that greater stability is achieved when the colloidal particles used during fabrication of the coated lithium-metal oxide electrodes are less than 25 nm, preferably less than 10 nm, and most preferably less than 4 nm.

### EXAMPLE 2

Li—ZrO₂-Coated LiMn₂O₄ Spinel Electrodes

The capacity vs. cycle number plot of a cell containing a LiMn₂O₄ spinel electrode treated with a ZrO₂-colloidal suspension containing LiNO₃ such that the Li:Zr atomic ratio in the suspension was 0.1:1.0 is shown in FIG. 6c. The rate of capacity fade of this electrode (0.05 mAh/g per cycle over 37 cycles) in a lithium cell operated at 50° C. was superior to that of ZrO₂-coated LiMn₂O₄ spinel electrode (FIG. 6b, 0.12 mAh/g per cycle over 37 cycles), and demonstrates the advantage of including an alkali metal ion to the colloidal coating. The rate of capacity fade of the Li—ZrO₂-coated spinel electrode was substantially superior to that of an uncoated LiMn₂O₄ spinel electrode (FIG. 6a, 0.25 mAh/g per cycle over 37 cycles) in accordance with the principles of this invention.

### EXAMPLE 3

SiO₂-Coated LiMn₂O₄ Spinel Electrodes

The capacity vs. cycle number plot of a lithium cell containing a LiMn₂O₄ spinel electrode treated with a SiO₂-colloidal suspension is shown in FIG. 6d. The rate of capacity fade of this electrode (0.06 mAh/g per cycle over 37 cycles) in a lithium cell operated at 50° C. was significantly superior to that of the uncoated LiMn₂O₄ spinel electrode (FIG. 6a, 0.25 mAh/g per cycle over 37 cycles) in accordance with the principles of this invention.

### EXAMPLE 4

TiO₂-Coated Li_{1.03}Mn_{1.97}O₄ Spinel Electrodes

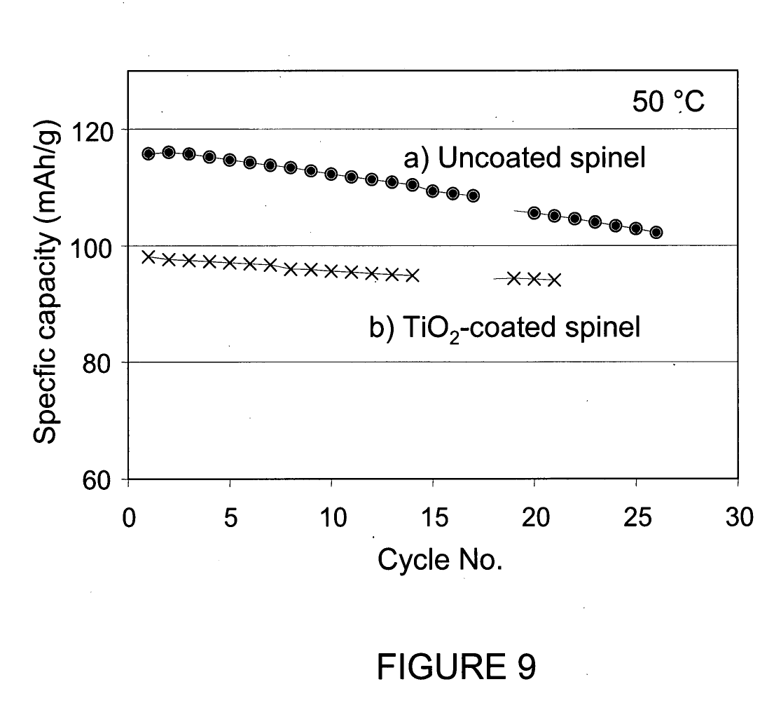

The capacity vs. cycle number plots of cells containing an uncoated lithium-substitued spinel electrode, Li_{1.03}Mn_{1.97}O₄, and a TiO₂-treated Li_{1.03}Mn_{1.97}O₄ electrode, when cells were cycled between 4.3 and 3.3 V at 50° C., are shown in FIG. 9. The lower capacity delivered by the TiO₂-treated LiMn₂O₄ spinel electrode is attributed to the relatively large amount of TiO₂ present in the sample (>10 wt %). Cells with TiO₂-treated LiMn₂O₄ spinel electrodes provided superior cycling stability compared to the uncoated electrode in accordance with the principles of this invention, the average rate of capacity fade of the TiO₂-treated electrodes being 0.21 percent per cycle, which is more than 50 percent less than the rate of capacity fade of the standard LiMn₂O₄ electrode (0.47 percent per cycle. The lower utilization of the coated electrode also reflects the electrochemical inactivity of the TiO₂ coating over the operating voltage of the cell.

### EXAMPLE 5

ZrO₂-Coated Li_{1.05}Mn_{1.90}Ni_{0.05}O₄ Spinel Electrodes

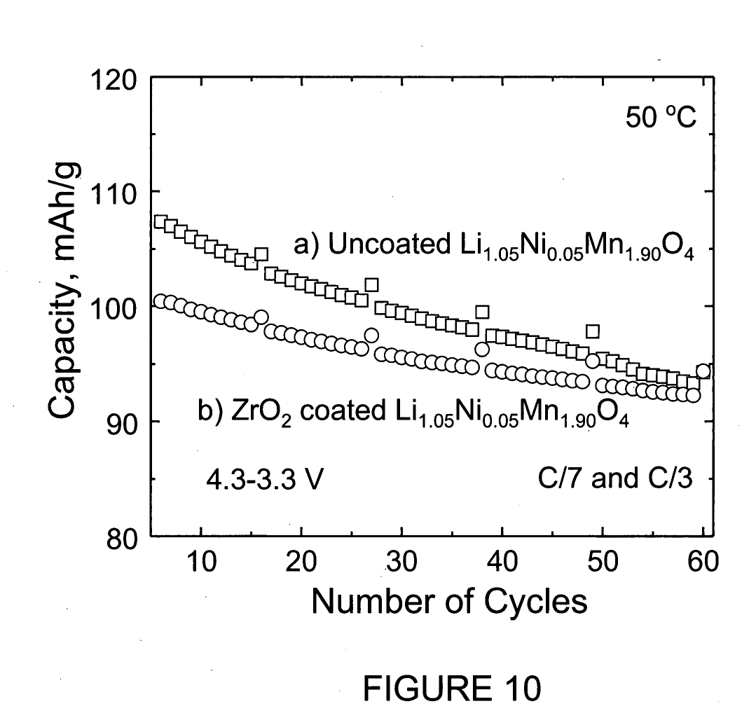

The capacity vs. cycle number plot of a lithium cell, operated at 50° C., containing an untreated, substituted Li_{1.05}Mn_{1.90}Ni_{0.05}O₄ spinel electrode is compared with that of a ZrO₂-coated Li_{1.05}Mn_{1.90}Ni_{0.05}O₄ electrode in FIGS. 10a and 10b, respectively. The rate of capacity fade of the ZrO₂-coated electrode (0.16 mAh/g per cycle between cycles 6 and 60) was significantly superior to that of the untreated electrode (0.28 mAh/g per cycle between cycles 6 and 60) in accordance with the principles of this invention.

### EXAMPLE 6

ZrO₂-Coated LiMn_{0.5}Ni_{0.5}O₂ Layered Electrodes

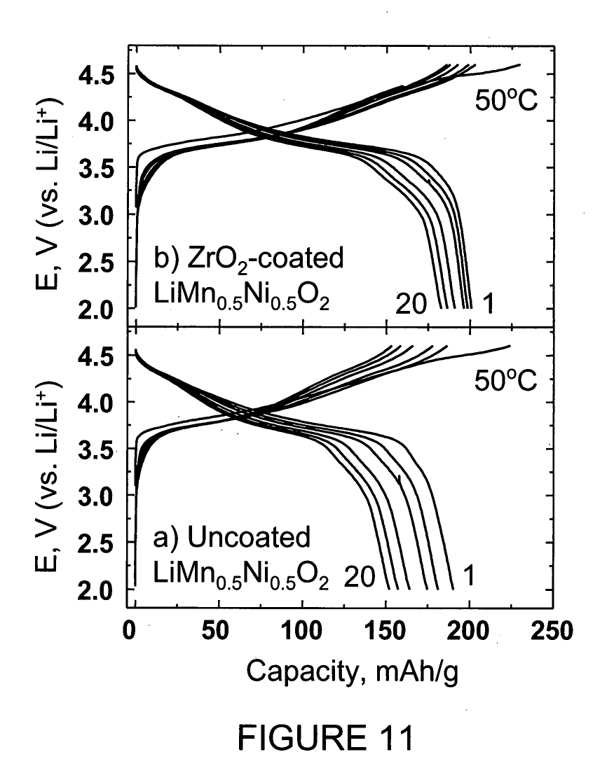

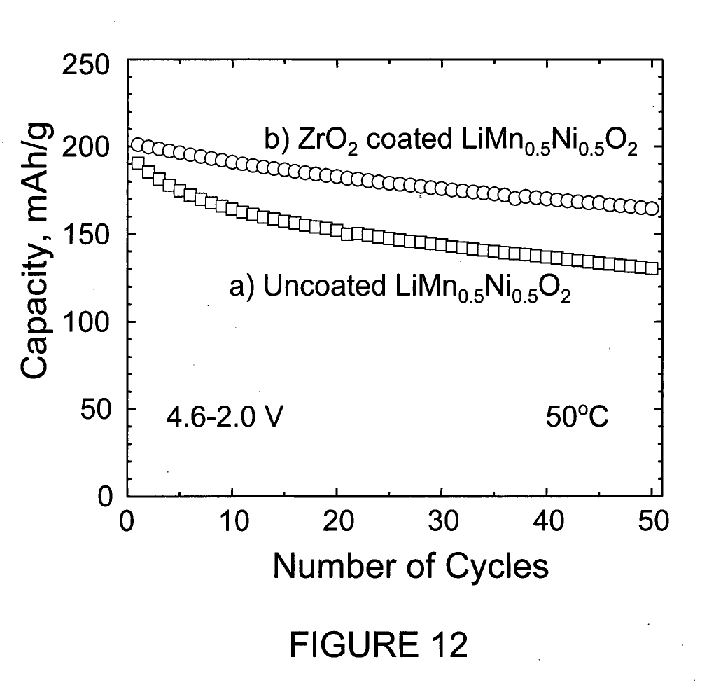

The voltage profiles of lithium cells, containing a standard uncoated LiMn_{0.5}Ni_{0.5}O₂ layered electrode and a ZrO₂-coated LiMn_{0.5}Ni_{0.5}O₂ electrode, charged and discharged between 4.6 and 2.0 V at 50° C. for the first 20 cycles, are shown in FIGS. 11a and 11b, respectively. These data, together with the capacity vs. cycle number plots for the two cells, shown in FIGS. 12a and 12b, respectively, show a substantially superior cycling stability of the lithium cell containing the ZrO₂-coated LiMn_{0.5}Ni_{0.5}O₂ electrode, in accordance with the principles of this invention. In this example, the rate of capacity fade over the first 50 cycles for the uncoated LiMn_{0.5}Ni_{0.5}O₂ electrode was 1.2 mAh/g per cycle, whereas for the ZrO₂-coated electrode the rate of capacity fade was only 0.7 mAh/g per cycle. In addition, in this example, a significantly superior capacity was delivered by the ZrO₂-coated LiMn_{0.5}Ni_{0.5}O₂ electrode, which yielded 164 mAh/g after 50 cycles, compared to 130 mAh/g delivered by the uncoated LiMn_{0.5}Ni_{0.5}O₂ electrode. By comparison, a layered LiMn_{0.5}Ni_{0.5}O₂ electrode coated with 4 weight percent ZrO₂, heated to 500° C., showed a capacity loss of 1.0 mAh/g per cycle over 45 cycles, i.e., 43% faster than the coated electrode that had been heated at 300° C., thereby demonstrating the advantage of using the lower heat treatment temperature.

The examples and data provided above demonstrate the principles of this invention with reference to lithium-metal-oxide and lithium-metal-oxyfluoride electrodes, preferably with spinel- and layered-type structures, treated preferably with colloidal oxides, oxyhydroxides or hydroxides such as ZrO₂, Li—ZrO₂, Al₂O₃, AlOOH, TiO₂, and SiO₂ optionally containing or mixed with metal ions selected from the Group 1a, 2a and 2b elements improve the stability of lithium cells to electrochemical cycling, particularly at temperatures above room temperature. The invention extends to methods of providing and using the electrodes.

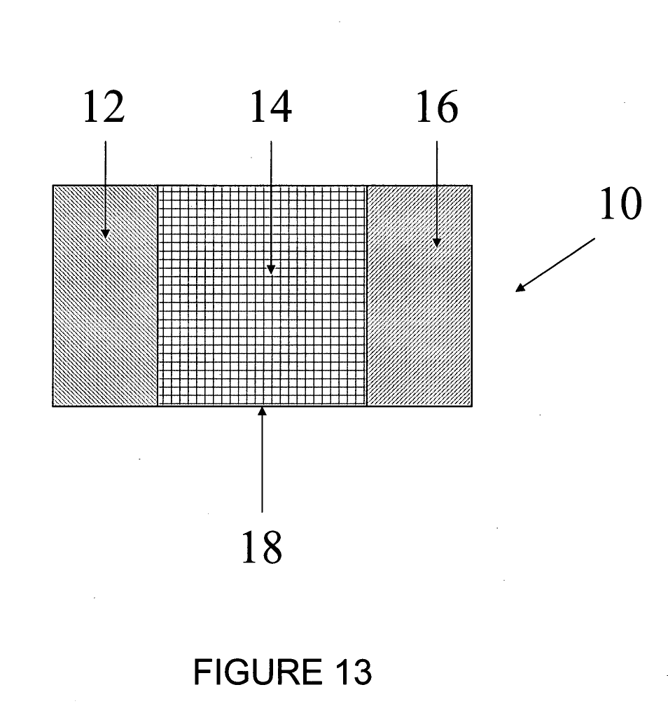

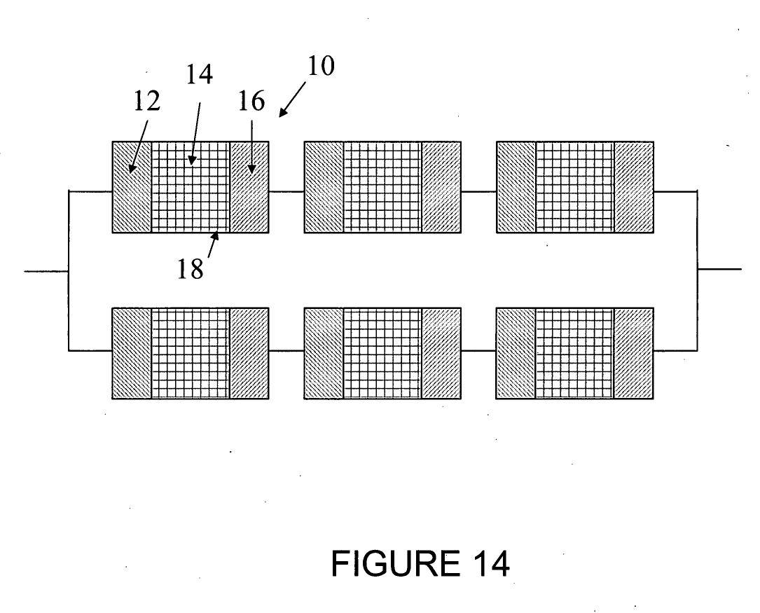

This invention, therefore, relates to positive electrodes for electrochemical cells and methods of making same, as shown schematically in FIG. 13, the cell represented by the numeral 10 having a negative electrode 12 separated from a positive electrode 16 by an electrolyte 14, all contained in an insulating housing 18 with suitable terminals (not shown) being provided in electronic contact with the negative electrode 12 and the positive electrode 16. Binders and other materials normally associated with both the electrolyte and the negative and positive electrodes are well known in the art and are not fully described herein, but are included as is understood by those of ordinary skill in this art. FIG. 14 shows a schematic illustration of one example of a battery in which two strings of electrochemical cells 10, described above, are arranged in parallel, each string comprising three cells arranged in series.

While there has been disclosed what is considered to be the preferred embodiments of the present invention, it is understood that various changes in the details may be made without departing from the spirit, or sacrificing any of the advantages of the present invention and that additional improvements in the capacity and stability of the electrodes can be expected to be made in the future by improving and optimizing the processing techniques whereby electrodes are coated with protective layers.

The embodiments of the invention in which an exclusive property or privilege is claimed are defined as follows:

1. A positive electrode for an electrochemical cell comprising a lithium transition-metal-oxide or lithium-transition metal-oxyfluoride having deposited thereon at least one oxide, oxyhydroxide or hydroxide of zirconium, aluminum, titanium, yttrium, silicon or mixtures thereof, the particles being less than 4 nm in longest dimension.

2. A positive electrode according to claim 1, in which the lithium-metal-oxide or lithium-metal-oxyfluoride has a spinel-type or layered-type crystal structure.

3. A positive electrode according to claim 1, in which the oxide or oxyhydroxide is ZrO₂, Al₂O₃, AlOOH, TiO₂, Y₂O₃ or SiO₂.

4. A positive electrode according to claim 1, in which the oxide is ZrO₂.

5. A positive electrode according to claim 1, in which the particles form a surface coating less than 100 nm thick.

6. A positive electrode according to claim 5, in which the surface coating is less than 50 nm thick.

7. A positive electrode according to claim 4, in which the surface coating is less than 10 nm thick.

8. The positive electrode of claim 1, wherein one or more ions from Group 1a, 2a or 2b elements are present with the deposited particles.

9. A positive electrode according to claim 8, in which the atomic ratio of the Group 1a, 2a or 2b elements to zirconium, aluminum, titanium, ytrrium or silicon is less than or equal to 2:1.

10. A positive electrode according to claim 9, in which the atomic ratio is less than or equal to 1:1.

11. A positive electrode according to claim 10, in which the atomic ratio is less than or equal to 0.1:1.

12. A positive electrode according to claim 8, containing one or more of ZrO₂, Al₂O₃, AlOOH, TiO₂, Y₂O₃ or SiO₂ and one or more of Li⁺, Mg²⁺, Ca²⁺, Ba²⁺ or Zn²⁺ ions.

13. A positive electrode according to claim 12, containing one or more of ZrO₂, Al₂O₃ or AlOOH and Li⁺ ions.

14. A positive electrode according to claim 13, containing ZrO₂ and Li⁺ ions.

15. A positive electrode according to claim 1, wherein said particles are from a colloid dried at a temperature not greater than 500° C.

16. The positive electrode of claim 15, wherein one or more ions from Group 1a, 2a, or 2b elements are present with the deposited particles.

17. A positive electrode according to claim 16, containing one or more of ZrO₂, Al₂O₃, AlOOH, TiO₂, Y₂O₃ or SiO₂ and Li⁺, Mg²⁺, Ca²⁺, Ba²⁺ or Zn²⁺ ions.

18. A positive electrode according to claim 17, containing ZrO₂ and Li⁺ ions

19. A positive electrode according to claim 1 and further including a negative electrode and an electrolyte forming an electrochemical cell.

20. The electrochemical cell of claim 19, replicated and connected in series or parallel to form a battery.

21. A positive electrode for an electrochemical cell consisting essentially of one or more of a lithium-transition metal-oxide or a lithium-transition metal-oxyfluoride having deposited thereon particles with the longest dimension thereof less than 25 nm of one or more of an oxide, a hydroxide, or an oxyhydroxide of one or more of Zr, Al, Ti, Y and Si.

22. A positive electrode according to claim 21, the colloidal particles being less than 10 nm in dimension.

23. A positive electrode according to claim 21, the colloidal particles being less than 4 nm in dimension.

24. A positive electrode according to claim 21, in which the lithium-metal-oxide or lithium-metal-oxyfluoride has a spinel-type or layered-type crystal structure.

25. A positive electrode according to claim 21, in which the colloidal oxide or oxyhydroxide is one or more of ZrO₂, Al₂O₃, AlOOH, TiO₂, Y₂O₃ or SiO₂.

26. A positive electrode according to claim 25 in which the oxide is ZrO₂.

27. A positive electrode according to claim 21, in which the particles form a surface coating less than 100 nm thick.

28. A positive electrode according to claim 27, in which the surface coating is less than 50 nm thick.

29. A positive electrode according to claim 27, in which the surface coating is less than 10 nm thick.

30. A positive electrode according to claim 21, wherein the particles are deposited and dried from a colloid at a temperature not greater than 500° C.

31. A positive electrode according to claim 21 and further including a negative electrode and an electrolyte forming an electrochemical cell.

32. The electrochemical cell of claim 31, replicated and connected in series or parallel to form a battery.

33. A method of making a positive electrode for an electrochemical cell, comprising providing a lithium-metal-oxide or lithium-metal-oxyfluoride positive electrode for a non-aqueous lithium cell, providing one or more oxide, oxyhydroxide or hydroxide having particles deposited thereon of not more than 4 nm in longest dimension selected from one or more of zirconium, aluminum, titanium, yttrium or silicon.

34. The method of claim 33, wherein said particles contain or are mixed with ions of at least one of the Group 1a, 2a, or 2b elements, and depositing and drying particles of said one or more oxide, oxyhydroxide, or hydroxide onto the electrode at a temperature not to exceed 500° C.

35. A method according to claim 34, in which a lithium-metal-oxide or lithium-metal-oxyfluoride is stirred in at least one colloidal suspension of one or more of zirconium, aluminum, titanium, yttrium or silicon oxide, oxyhydroxide or hydroxide particles containing ions of at least one of the Group 1a, 2a, or 2b elements, dried, and fired at a temperature between 100 and 500° C.

36. A method according to claim 35 in which the firing temperature is between 300 and 400 ° C.

37. A method of making a positive electrode for an electrochemical cell, consisting essentially of providing a lithium-metal-oxide or lithium-metal-oxyfluoride positive electrode for a non-aqueous lithium cell, providing a colloid having particles of one or more of an oxide, oxyhydroxide or hydroxide not more than 25 nm in longest dimension selected from one or more of zirconium, aluminum, titanium, yttrium or silicon, and depositing and drying particles of the colloid on the lithium-metal oxide or lithium-metal-oxyfluoride, depositing and drying said one or more colloidal oxide, oxyhydroxide, or hydroxide onto the electrode.

38. A positive electrode for an electrochemical cell, comprising one or more of a lithium-transition metal-oxide or a lithium-transition metal-oxyfluoride having deposited thereon particles of one or more of an oxide, oxyhydroxide or hydroxide of one or more of Zr, Al, Ti, Y or Si having a morphology substantially as seen in one or more of FIGS. 3a to 3d.

39. The positive electrode of claim 38, having a morphology substantially as seen in FIG. 3b.
